(19) United States
(12) Patent Application Publication
(10) Pub. No.: US 2018/0295879 A1
(43) Pub. Date: Oct. 18, 2018

(54) REWARD-DISPENSING, CIGARETTE-WASTE RECEPTACLE

(71) Applicant: Gyro, LLC, San Francisco, CA (US)

(72) Inventors: Jason M. Francis, Concord, CA (US); Toby L. Peterson, San Francisco, CA (US); Janis W. K. Chan, San Francisco, CA (US); Marissa N. Langman, San Francisco, CA (US); Vinit Patil, Alameda, CA (US)

(73) Assignee: Gyro, LLC, San Francisco, CA (US)

(21) Appl. No.: 15/956,559

(22) Filed: Apr. 18, 2018

Related U.S. Application Data
(60) Provisional application No. 62/486,900, filed on Apr. 18, 2017.

(51) Int. Cl. A24F 19/10; B65D 83/04

(52) U.S. Cl. CPC A24F 19/10; B65F 1/08; B65D 83/0409

(57) ABSTRACT

A system comprising a housing having an input device configured to receive cigarette waste and a reward delivery device configured to dispense a reward in exchange for the cigarette waste.

### REFERENCE TO RELATED APPLICATIONS

The present application claims priority to U.S. Provisional Patent Application No. 62/486,900, filed Apr. 18, 2017, the entire contents of which are incorporated into this application by reference.

### FIELD OF THE INVENTION

This invention relates generally to a cigarette waste receptacle and, more particularly, to a system for dispensing a reward in exchange for cigarette waste.

### BACKGROUND

While cigarette smoking has decreased in the United States, cigarette butts are the most frequently littered item in the world. In fact, a survey of smokers found that nearly 35% toss five or more cigarette butts per pack on the ground. As a result, nearly 1.7 billion pounds of cigarette butts become litter each year, creating an enormous environmental, health, and economic burden. In fact, tobacco products comprise more than one third of all U.S. roadway and storm drain litter.

Moreover, the seemingly innocuous cigarette butt contains hazardous materials that persist in the environment. This toxic litter is often mistaken for food and ingested by wildlife, pets, and small children. In addition to creating an unsightly mess as it accumulates in public places, cigarette litter is easily carried through drainage systems to local streams, rivers, and waterways. This creates countless problems, from the bioaccumulation of poisons up the food chain to damage to commercial fisheries and water supplies.

It should be appreciated that there is a need for a system that incentivizes smokers to properly dispose of their cigarette waste. The present invention fulfills this need and provides further related advantages.

### BRIEF SUMMARY OF THE INVENTION

The present invention is embodied in a system comprising a housing having an input device configured to receive cigarette waste and a reward delivery device configured to dispense a reward in exchange for the cigarette waste.

In one embodiment, the system can further comprise a cigarette waste container within an interior space defined by the housing. In another embodiment, the cigarette waste container can be configured to collect the received cigarette waste.

In one embodiment, the system can further comprise a reward container within the interior space defined by the housing. In another embodiment, the reward container can be configured to contain the reward.

In one embodiment, the system can further comprise a sensor coupled to the input device and in electronic communication with the reward delivery device. In another embodiment, the sensor can be configured to generate a control signal to initiate dispersal of the reward when it detects cigarette waste in the input device. In a further embodiment, the sensor can comprise a thermal heat sensor. In an additional embodiment, the reward delivery device can release a reward from the reward container in response to the control signal generated by the sensor.

In one embodiment, the system can further comprise an access opening in the housing for removing the cigarette waste container and the reward container.

In one embodiment, the system can further comprise an indicator coupled to the housing and in electronic communication with the sensor. In another embodiment, the indicator can be responsive to the control signal to provide a visual confirmation when the sensor detects cigarette waste in the input device. In a further embodiment, the indicator can comprise a display.

In one embodiment, the system can further comprise a power source. In another embodiment, the power source can comprise a solar panel.

In one embodiment, the cigarette waste container can be removable from the housing. In another embodiment, the cigarette waste container can comprise a thermal containment system.

In one embodiment, the reward can comprise a mint. In another embodiment, the reward can be selected from the group consisting of a credit, a gift card, a rebate, and a coupon.

The present invention is also embodied in a system comprising a housing defining an interior space, an input device coupled to the housing, a cigarette waste container within the interior space, a reward container within the interior space, a thermal heat sensor coupled to the input device, and a reward delivery device coupled to the housing and in electronic communication with the sensor.

In one embodiment, the input device can be configured to receive cigarette waste. In another embodiment, the cigarette waste container can be configured to collect the received cigarette waste. In a further embodiment, the reward container can be configured to contain a reward. In an additional embodiment, the thermal heat sensor can be configured to generate a control signal when it detects cigarette waste in the input device. In yet another embodiment, the reward delivery device can be configured to release a reward from the reward container in response to the control signal.

In one embodiment, the system can further comprise an access opening in the housing for removing the cigarette waste container and the reward container.

In one embodiment, the system can further comprise an indicator coupled to the housing and in electronic communication with the sensor. In another embodiment, the indicator can be responsive to the control signal to provide a visual confirmation when the sensor detects cigarette waste in the input device.

In one embodiment, the system can further comprise a power source. In another embodiment, the power source can comprise a solar panel.

In one embodiment, the reward can comprise a mint. In another embodiment, the reward can be selected from the group consisting of a credit, a gift card, a rebate, and a coupon.

Other features and advantages of the invention should become apparent from the following description of the preferred embodiments, taken in conjunction with the accompanying drawings, which illustrate, by way of example, the principles of the invention.

### BRIEF DESCRIPTION OF THE DRAWINGS

FIG. 1 is a perspective view of a cigarette waste receptacle system in accordance with one embodiment.

FIG. 2 is a perspective view of a cigarette waste receptacle system having an open access door, in accordance with one embodiment.

### DETAILED DESCRIPTION OF THE PREFERRED EMBODIMENTS

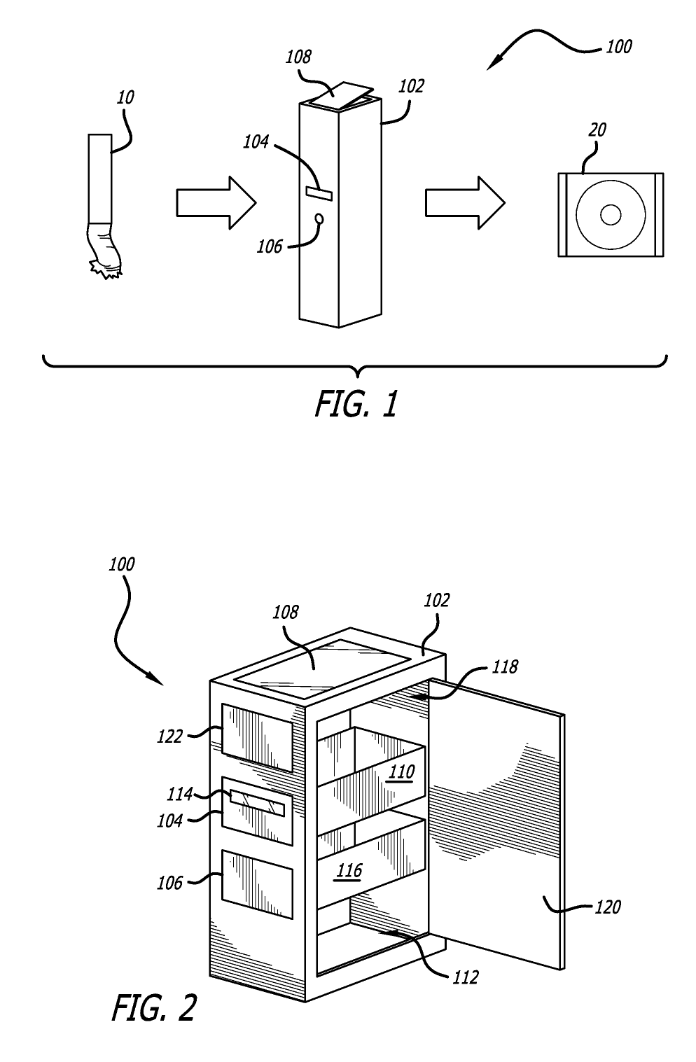

With reference now to FIG. 1 of the illustrative drawings, there is shown a system 100 for dispensing a reward 20 in exchange for cigarette waste 10, in accordance with one embodiment.

The present invention is embodied in a system 100 comprising a housing 102 having an input device 104 configured to receive cigarette waste 10 and a reward delivery device 106 configured to dispense a reward 20 in exchange for the cigarette waste.

In general, the reward 20 can be any small, inexpensive item that is desirable to a smoker. The reward 20 should incentivize the proper disposal of cigarette waste 10. In one embodiment, the reward 20 can comprise a mint 20. In another embodiment, the reward can be selected from a group consisting of a credit, a gift card, a rebate, and a coupon.

The housing 102 is shown as a narrow rectangular cuboid, but it can also have the shape of a prism, cylinder, cone, or sphere. In one embodiment, the housing 102 features a narrow, limited form factor and a compact design. The housing 102 can comprise any suitable material (e.g., metal or plastic), but preferably comprises a recycled or otherwise sustainable material.

With reference to FIG. 2, in one embodiment, the input device 104 can be configured to accept the cigarette waste 10. In another embodiment, the input device 104 can be configured to allow the inserted cigarette waste 10 to pass through the input device 104 and into a cigarette waste container 110 within an interior space 112 defined by the housing 102. In a further embodiment, the cigarette waste container can be removable from the housing 102. In an additional embodiment, the cigarette waste container 110 can include a thermal containment system to prevent the system 100 from igniting from the accumulation of cigarette waste 10.

In one embodiment, the input device 104 is configured to determine whether waste inserted into the input device 104 is actually cigarette waste 10. For example, in another embodiment, the system 100 can comprise a sensor 114 coupled to the input device 104. In a further embodiment, the sensor 114 can be configured to generate a control signal to initiate dispersal of a reward 20 when the sensor 114 detects cigarette waste 10 in the input device 104. For example, in yet another embodiment, the sensor 114 can comprise a thermal heat sensor.

In one embodiment, the system 100 can further comprise a reward container 116 within the interior space defined by the housing 102. In another embodiment, the reward container 116 can be configured to contain the reward 20. In a further embodiment, the reward container 116 can be in communication with the reward delivery device 106, and the reward 20 can pass from the reward container 116 to the reward delivery device 106 so that it can be accessed by the buyer who deposited the cigarette waste 10 into the input device 104. In an additional embodiment, the sensor 114 can be in electronic communication with the reward delivery device 106. In yet another embodiment, the reward delivery device 106 can cause the reward 20 to be released from the reward container 116 in response to the control signal generated by the sensor 114.

In one embodiment, the system 100 can further comprise an access opening 118 in the housing for removing the cigarette waste container 110 and the reward container 116. In another embodiment, the access opening 118 can comprise an access door 120. The access door 120 can be secured by a lock to prevent unauthorized access to the interior space 112 defined by the housing 102. An authorized technician can open the access door 120 to remove the cigarette waste 10 from the waste container 110 or replenish the supply of rewards 20 in the reward container 116.

In one embodiment, the system 100 can further comprise an indicator 122 coupled to the housing 102 and in electronic communication with the sensor 114. In another embodiment, the indicator 122 can be responsive to the control signal to provide a visual confirmation when the sensor 114 detects cigarette waste 10 in the input device 104. In a further embodiment, the indicator 122 can comprise a display. In an additional embodiment, the display can be configured to present a message in response to the control signal.

In one embodiment, the system 100 can further comprise a power source 108. In another embodiment, the power source can comprise a solar panel 108.

It should be appreciated from the foregoing description that the present invention provides an improved cigarette waste receptacle that not only provides a safe receptacle for cigarette waste, but that also provides a reward system for encouraging the proper disposal of cigarette waste.

Specific methods, devices, and materials are described, although any methods and materials similar or equivalent to those described can be used in the practice or testing of the present embodiment. Unless defined otherwise, all technical and scientific terms used herein have the same meanings as commonly understood by one of ordinary skill in the art to which this embodiment belongs.

The terms “a,” “an,” and “at least one” encompass one or more of the specified element. That is, if two of a particular element are present, one of these elements is also present and thus “an” element is present. The terms “a plurality of” and “plural” mean two or more of the specified element. The term “or” used between the last two of a list of elements means any one or more of the listed elements. For example, the phrase “A, B, or C” means “A, B, and/or C,” which means “A,” “B,” “C,” “A and B,” “A and C,” “B and C,” or “A, B, and C.” The term “coupled” generally means physically coupled or linked and does not exclude the presence of intermediate elements between the coupled items absent specific contrary language.

Without further elaboration, it is believed that one skilled in the art, using the proceeding description, can make and use the present invention to the fullest extent. The invention has been described in detail with reference only to the presently preferred embodiments. Persons skilled in the art will appreciate that various modifications can be made without departing from the invention. Accordingly, the invention is defined only by the following claims.

1. A system comprising a housing having an input device configured to receive cigarette waste and a reward delivery device configured to dispense a reward in exchange for the cigarette waste.

2. The system of claim 1, further comprising a cigarette waste container within an interior space defined by the housing, the cigarette waste container configured to collect the received cigarette waste.

3. The system of claim 2, further comprising a reward container within the interior space defined by the housing, the reward container configured to contain the reward.

4. The system of claim 3, further comprising a sensor coupled to the input device and in electronic communication with the reward delivery device, wherein the sensor is configured to generate a control signal to initiate dispersal of the reward when it detects cigarette waste in the input device.

5. The system of claim 4, wherein the sensor comprises a thermal heat sensor.

6. The system of claim 4, wherein the reward delivery device will release the reward from the reward container in response to the control signal generated by the sensor.

7. The system of claim 3, further comprising an access opening in the housing for removing the cigarette waste container and the reward container.

8. The system of claim 4 further comprising an indicator coupled to the housing and in electronic communication with the sensor, the indicator responsive to the control signal to provide a visual confirmation when the sensor detects cigarette waste in the input device.

9. The system of claim 8, wherein the indicator comprises a display.

10. The system of claim 4 further comprising a power source.

11. The system of claim 10, wherein the power source comprises a solar panel.

12. The system of claim 7, wherein the cigarette waste container is removable from the housing.

13. The system of claim 2, wherein the cigarette waste container comprises a thermal containment system.

14. The system of claim 1, wherein the reward comprises a mint.

15. A system comprising:
a housing defining an interior space;
an input device coupled to the housing and configured to receive cigarette waste;
a cigarette waste container within the interior space, the cigarette waste container configured to collect the received cigarette waste;
a reward container within the interior space, the reward container configured to contain a reward;
a thermal heat sensor coupled to the input device, wherein the thermal heat sensor is configured to generate a control signal when it detects cigarette waste in the input device; and
a reward delivery device coupled to the housing and in electronic communication with the sensor, the reward delivery device configured to release a reward from the reward container in response to the control signal.

16. The system of claim 15, further comprising an access opening in the housing for removing the cigarette waste container and the reward container.

17. The system of claim 15, further comprising an indicator coupled to the housing and in electronic communication with the sensor, the indicator responsive to the control signal to provide a visual confirmation when the sensor detects cigarette waste in the input device.

18. The system of claim 17 further comprising a power source.

19. The system of claim 18, wherein the power source comprises a solar panel.

20. The system of claim 15, wherein the reward comprises a mint.
